(19) United States
(12) Patent Application Publication
(10) Pub. No.: US 2004/0093619 A1
(43) Pub. Date: May 13, 2004

(54) Method and system for effective switching between set-top box services

(76) Inventor: David Cox, Oakville (CA)

Correspondence Address: Martin Korn, Locke Liddell & Sapp LLP, Ste. 2200, 2200 Ross Ave., Dallas, TX, 75201, US

(21) Appl. No.: 10/292,499

(22) Filed: Nov. 13, 2002

(51) Int. Cl. H04N 7/173; G06F 3/00; H04N 5/445; G06F 13/00

(52) U.S. Cl. 725/110; 725/61

(57) ABSTRACT

The invention relates generally to convergent multimedia systems, and more specifically, to effective switching between different services in a television set-top box (STB) environment. Two services which are often supported by STBs are regular television, and Internet over television (IoTV) services. Most STBs only have the resources to support one service at a time—thus, to toggle between a television program and an email service, the user must close the television program window and launch a new software application for the email service. Opening and closing software applications is a slow process, and the state of IoTV applications is lost when they are closed. The invention provides a method of operation for a STB which responds to toggle commands by switching the users display between the television and IoTV services, but keeping the IoTV service operable and its state current even when the user is viewing the television service.

The present invention relates generally to convergent multimedia systems, and more specifically, to a method and system which allows effective switching between different services in a television set-top box (STB) environment.

### BACKGROUND OF THE INVENTION

Over the last two decades, telecommunication services have seen tremendous change. The familiar analogue telephones, radios, televisions and recording devices are being, or have already been, replaced with higher quality, more powerful and more flexible digital devices.

Television broadcasting, for example, traditionally offered no more than thirty or forty channels, available on a local basis using analogue cable networks or short-range wireless FM (frequency modulated) transmissions. Digital satellite transmissions now offer hundreds of television channels and the broad footprint of satellite transmissions mean that these signals can be received across vast geographical areas. High definition television (HDTV) standards are also being established and widely accepted, offering much higher quality, which is almost a necessity for the wide-screen televisions common today. As well, pay-per-view, direct-to-home and video-on-demand services now allow Users to have access to more valuable viewing products, and on a more flexible scheduling basis.

The last decade has also seen the explosive growth of data communication networks such as the Internet, Wide Area Networks (WANs) and Local Area Networks (LANs), offering tremendously efficient means of organizing and distributing computerized data. These efficiencies have resulted in widespread use for both business and personal applications.

The Internet is an excellent carrier for multimedia applications because of the rich formatting that it supports, including for example: sound, animation and personal interaction with the End User. As well, access to the Internet is almost pervasive in developed countries. As a result, the Internet has become a common medium for operating online auctions, academic and public forums, retail shopping, remote computing, chatting, Internet radio and television broadcasts, distributing publications such as newspapers and magazines, and performing electronic mail (email) transactions.

While these telecommunication systems are already complex, there is a growing market for even more advanced services such as voice-over-IP (using the Internet as a voice telephone network), video telephony, Internet games, remote collaborative work and telemedicine. There is also pressure to support all of the services described above on single, “convergent” devices which makes the software and hardware development and support tasks even more complex.

One such convergent device which is showing great promise is the set-top box (STB). This device acts as an interface between a television or other audio/video presentation device, and various telecommunication media such as telephone lines, television cable networks and xDSL (digital subscriber line) facilities. Interconnectivity to other media or mediums may also interface over a local area network (LAN).

Two groups of services which are often supported by set-top boxes are regular television, and Internet over television (IoTV) services. Regular television broadcasts may be received via an analogue cable, antenna, or satellite receiver. IoTV services may be supported by any manner of Internet connection, and may include such services as Web browsing, email, chat or instant messaging.

Unfortunately, most set-top boxes only have the resources to support one service at a time. To toggle between a television program and an email service, for example, the user must close the television program window altogether and launch a new software application to open the email window. The closing of old applications and launching of new ones is a painfully slow process.

Also, when the user switches from an IoTV application back to the television viewing, the IoTV application is closed and its state is lost. In many cases, it is impossible for the User to recreate the state of the IoTV application in the previous session. At best, he can re-trace his earlier steps in an attempt to recreate the same state.

More advanced set-top box systems use a windowing system which allows the end user to switch back and forth between windows for different services, but these services typically run “blind”. That is, hidden applications are simply left alone until called upon by the user. When the user calls upon the service there is no guarantee that it will be in the proper state, or even that it will be working at all (i.e. it may not receive updates while it is dormant, and, in fact, it may have crashed while the user was running another application).

Users of television and telephone devices are used to having very high levels of reliability which simply do not exist on today's set-top box systems. System failures are particularly frustrating to the User when they are unexpected, or unprovoked. It would therefore be desirable to improve on the reliability of such systems.

A final problem with windows-based set-top box systems is that the user often has to navigate through layers of menus to locate the service they desire. This is very common in the set-top box environment, where much larger font sizes and icons must be used because the end user is generally much farther away than he would be if he was using a personal computer (PC). It is simply not practical for the Graphic User Interface (GUI) of a set-top box to display a large number of headings or icons simultaneously. Thus, each time the user wants to re-launch a service, even a service he uses all the time, he has to navigate through the multi-layer menu system.

If the above problems could be overcome, convergent devices could be offered which support diverse multimedia services, effectively and reliably. Such a system could be adopted to many electronic devices, and would not simply be limited to set-top boxes. There is therefore a need for a multi-media system and method, provided with consideration for the problems outlined above.

### SUMMARY OF THE INVENTION

It is therefore an object of the invention to provide a method and system which obviates or mitigates at least one of the disadvantages described above.

One aspect of the invention is broadly defined as a method of operating a convergent multimedia device comprising the steps of: responding to a toggle command being issued by an end user, by switching a display output between a first multimedia service and a second multimedia service; while automatically checking the operability of the second multimedia service on an ongoing basis; and responding to erroneous operation of the second multimedia service by taking corrective action as required.

Another aspect of the invention is defined as a convergent multimedia system comprising: an Internet Service Provider (ISP) connected to an Internet network; a convergent multimedia device connected a display screen and an audio output; a communication network connecting the convergent multimedia device to the ISP, allowing communication between the convergent multimedia device and the ISP; and a television broadcast network connected to the convergent multimedia device; the convergent multimedia device being operable to perform the steps of: responding to a toggle command being issued by an end user, by switching between a first multimedia service received via the television broadcast network and a second multimedia service received via the communication network connecting the convergent multimedia device to the ISP; while automatically checking the operability of the second multimedia service on an ongoing basis; and responding to erroneous operation of the second multimedia service by taking corrective action as required.

A further aspect of the invention is defined as a television set-top box comprising: means for responding to a toggle command being issued by an end user, by switching a display output between a first multimedia service and a second multimedia service; means for automatically checking the operability of the second multimedia service on an ongoing basis; and means for responding to erroneous operation of the second multimedia service by taking corrective action as required.

### BRIEF DESCRIPTION OF THE DRAWINGS

These and other features of the invention will become more apparent from the following description in which reference is made to the appended drawings in which:

FIGS. 1A and 1B present state diagrams of a method of operation for a convergent device in a broad embodiment of the invention;

FIG. 2 presents a block diagram of an exemplary convergent communication system in a broad embodiment of the invention;

FIG. 3 presents a block diagram of an exemplary convergent device in a broad embodiment of the invention;

FIGS. 4A and 4B present state diagrams of a method of operation for a set-top box in a preferred embodiment of the invention.

FIGS. 5A and 5B present a flow chart of a method of determining system health in a preferred embodiment of the invention; and

FIG. 6 presents a state diagram of a method of supporting IoTV applications in a preferred embodiment of the invention.

### DETAILED DESCRIPTION OF PREFERRED EMBODIMENTS OF THE INVENTION

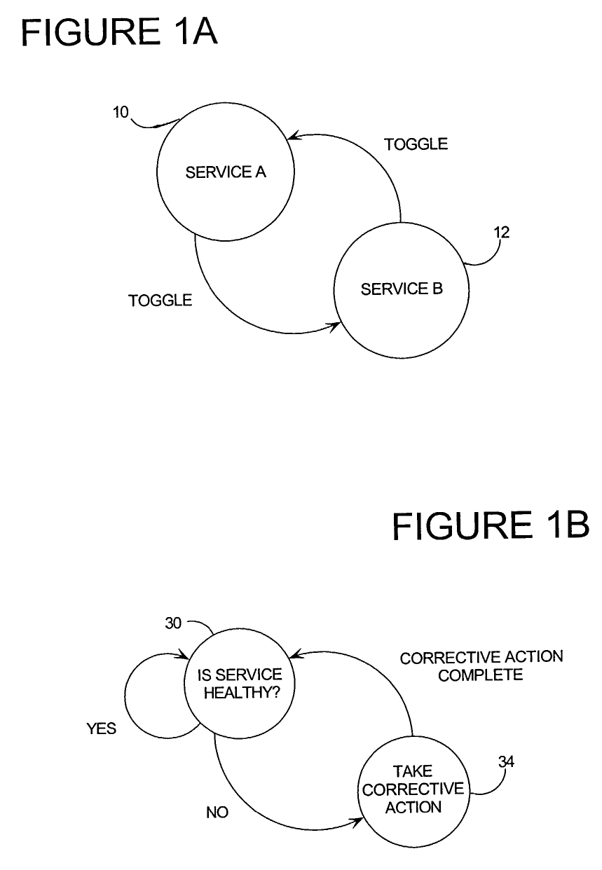

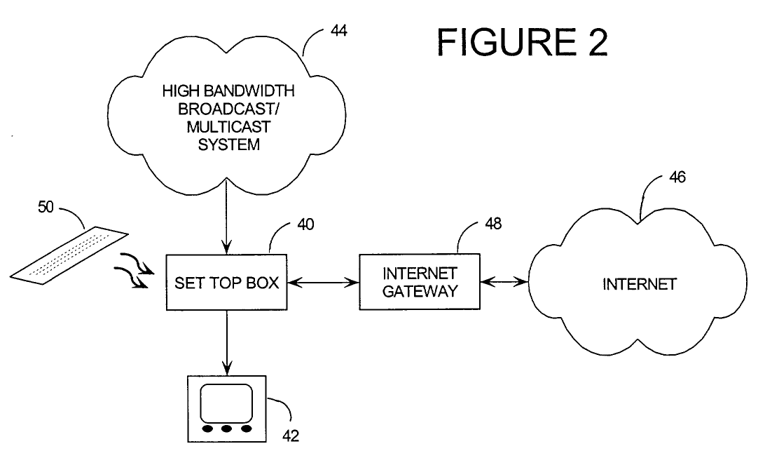

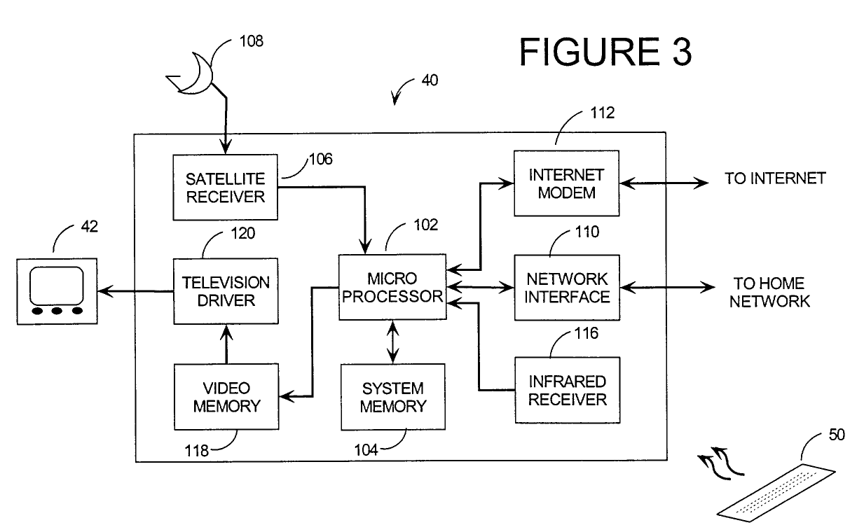

A system and methodology which addresses the objects outlined above, is presented in FIGS. 1 through 3. FIGS. 1A and 1B present state diagrams of the main methodology of the invention. FIGS. 2 and 3 present block diagrams of the physical system of the invention, FIG. 2 presenting the set-top box in a typical operating environment, and FIG. 3 present an exemplary block diagram of the set-top box itself.

The methodology of this multimedia system basically relies on two separate functions: a “toggle” function and a “maintenance” function.

The “toggle” function is a process which responds to a command being issued by the end user, by switching back and forth between two given multi-media applications. It may be considered analogous to the use of a “previous channel” command on a television remote control device.

In FIG. 1A, an exemplary process for implementing this functionality is presented. Simply, control can commence in either of states 10 or 12, in which the set-top box is displaying Service A or Service B respectively. Control passes to the other state in response to the toggle command being issued (i.e. if service A is active when the toggle command is received, the set-top box will display service B, and if service B is active when the toggle command is received, the set-top box will display service A).

Service A and service B could be any multimedia services including handwired or wireless broadcast television, or one of many IoTV applications (including chat, instant messaging, email or a Web browser). In the preferred embodiment which is described hereinafter, one service will typically be a regular television service, and the second service will be an IoTV service.

The technical exercise of switching the display and audio of the television from one service to another is not a major problem, in fact, most STBs already have a software switch to do this. However, it is not enough to simply toggle between the two services because returning to an IoTV service is only practical if the IoTV service is operating correctly when the User wishes to re-activate it. Hence, the requirement for the “maintenance” function.

The “maintenance” function is a process that maintains the multi-media services being toggled. It does this by automatically checking the operability of the multimedia service that is hidden, on an ongoing basis, and responding to erroneous operation of the hidden multimedia service by taking corrective action as required.

An exemplary state diagram for this process is presented in FIG. 1B. In state 30, the process will determine whether a service is healthy. If it is healthy, then control remains in state 30. If the service is not healthy, then control passes to state 34 where corrective actions are taken. Once the corrective actions are completed, control returns to state 30.

The maintenance function could be used to monitor the operability of any multimedia service, and may be effected on either of the two services identified in FIG. 1A, or both of them. However, traditional broadcast television services are generally very reliable, and there is little corrective action that could be taken even if a failure was detected, so it would generally not be necessary to monitor these types of services. Thus, in general, regular TV applications will not be supported in the manner of FIG. 1B, but IoTV applications will.

The nature of the corrective actions being performed in state 34 will depend on the nature of the service being supported. If it is a Web browsing service, for example, the corrective action may include re-booting the browsing software or reinitializing the connection to the Internet Service Provider (ISP). More details are included in the description of other embodiments of the invention hereinafter.

The functionality of these two state diagrams could be effected in many ways and in any operating environment, including the following:

1. the routine of FIG. 1A could be launched in response to a request from the end issuer, which would issue an interrupt to the microprocessor;

2. the routine of FIG. 1B could be running continuously, or performed on a periodic basis (say, every five minutes, in response to a call from a software timer);

3. both routines could run simultaneously in a multi-tasking or multi-threading environment; or

4. both routines could be managed by a separate software layer in a non-multitasking environment.

Other implementations would be clear to one skilled in the art.

As noted above, FIG. 2 lays out a block diagram of an exemplary system for implementing the invention. In this example, the User accesses his multi-media content via a set-top box 40 and television 42. The set-top box 40 receives high-bandwidth data from an external source of some kind 44. This high-bandwidth source 44 could distribute content using broadcast, multi-cast, narrow cast, unicast or other techniques, and access customers using various high-bandwidth communication media (including satellite, cable, digital cable, point-to-point wireless HFC and xDSL communications). The only restriction on this high-bandwidth source 44 is that it must be able to offer connection-oriented, high-bandwidth services. Techniques for such a system employing these three components (set-top box 40, Television 42 and high bandwidth source 44) are well known in the art.

The set-top box 40 may have functionality to support a direct connection to the Internet 46, but will generally require an Internet Gateway 48 of some sort, as an interface. There are many bi-directional techniques for accessing the Internet 46, including for example: dial-up modems using telephone lines, DSL (digital subscriber line) over telephone lines, television cable modems, wireless local loops, point-to-point wireless and via cellular telephone networks.

As well, the set-top box 40 must have some manner of input for the user. In FIG. 2, a wireless alpha-numeric keyboard 50 is shown, but other input devices could also be used, such as: wireless handheld control devices, hard-wired controllers, touch-screens, mouses, track-balls, or joysticks. Wireless controllers often use infra-red (IR) or radio frequency (RF) technology to communicate, though other techniques could also be used. Input devices for STB's often have dedicated keys to support functions such as volume adjustment, channel selection and keys for launching specific applications. However, much less sophisticated remote control hand held devices may also be used by making the GUI more comprehensive.

The nature of the input interface will depend on the services the STB is intended to support. Wireless devices allow users to move around a room without the inconvenience of dangling wires. Touch-screens and trac-balls require the user to be very close to the screen, but would be less prone to damage in a public setting.

The system of FIG. 2 could also have additional components, such as a connection to a Home Network or LAN, such as an Ethernet or the like. This kind of network would typically be required to interface with a personal computer, printer, scanner, Internet fax machine or similar appliance. The functionality of the system and components external to the set-top box 40, determines the design of the set-top box itself 40.

A set-top box 40 which provides the functionality described above could be embodied in many different forms using many different architectures. The embodiments of the invention are generally described herein with respect to a television set-top box 40, but it is understood that the invention could also be implemented on other convergent devices. For example, the functionality of the invention could be made integral to a television, a Personal Computer (PC) or similar device.

An exemplary television set-top box 40 that is compatible with the system of FIG. 2 and method of FIG. 1, is presented as a block diagram in FIG. 3. At the heart of the set-top box 40 lies a microprocessor 102 which controls all of the data processing input/output and software applications. While a generic microprocessor such as a Pentium III could be used, dedicated microprocessors, digital signal processors (DSPs), micro-controllers or application specific integrated circuits (ASICs) could also be used.

Software for controlling the microprocessor 102, software applications and data content is stored on the system memory 104. The system memory 104 could be comprised of read only memory (ROM), random access memory (RAM) or various high density storage media such as magnetic disk drives (hard disks), optical drives such as CD ROMs or DVDs, or other bulk storage media as known in the art. Typically, the system memory 104 will include a combination of these volatile and non-volatile memories to store an operating system, Web browsers, email software and other software applications.

The set-top box (STB) 40 also includes a satellite receiver 106 for receiving video data via an external satellite antenna or dish 108. Note that such a device will generally only receive satellite data and not have the functionality to transmit data.

The STB 40 may also communicate with a home local network via a network interface card 110. This is a bi-directional channel as data may be received or transmitted to the home network. Ethernet, USB and RS-232 cards are common examples of such a network interface card 110. As noted above, the connection to a home local network may be desirable to access a local PC, printer, scanner, or similar appliance.

The STB 40 may also include an internal modem 112 for communicating with the Internet 46. This modem 112 may be used to contact an Internet Service Provider to obtain Internet access over telephone lines, a cable television network or a wireless communication network. Alternatively, the interconnection to the Internet 46 may be made via the local area network, in which case the set-top box 40 itself may not include an internal modem 112.

As noted above, the STB 40 also requires an interface with the User. In the preferred embodiment, this interface is provided by an external alpha-numeric keyboard 50 which communicates with the STB 40 using a wireless infrared (IR) connection and an infrared pickup 116 in the STB 40.

Finally, output video and audio data is stored in the video memory 118 of the STB 40 and is processed as required by the television driver 120 before being transmitted to the television 42. Other display devices may also be used besides a television 42, including: PCs, Personal Digital Assistants (PDAs), public information kiosks, and dedicated display devices.

The interconnection between the set-top box 40 and the television 42 may be effected in a number of manners as known in the art, for example:

1. the use of line level audio and video connections;

2. the use of separate luminance and chrominance signals, for example, in an SVHS format; or

3. by modulating the audio and video signals onto a carrier channel such as channel 3 or 4. Such an arrangement may be necessary for television sets 42 not having separate audio and video inputs.

It will be appreciated by those skilled in the art that the block diagram of FIG. 3 is greatly simplified. It is common, for example, for set-top boxes 40 to have the functionality to super-impose alpha-numeric characters, other symbols and bitmap graphics over the video images stored in the video memory 118. As well, the set-top boxes 40 may have various tuners, modulators/demodulators, decoders/decrypters, demultiplexers, filters, and cable connections. However, such details are known in the art and will not be addressed herein.

### DESCRIPTION OF PREFERRED EMBODIMENTS OF THE INVENTION

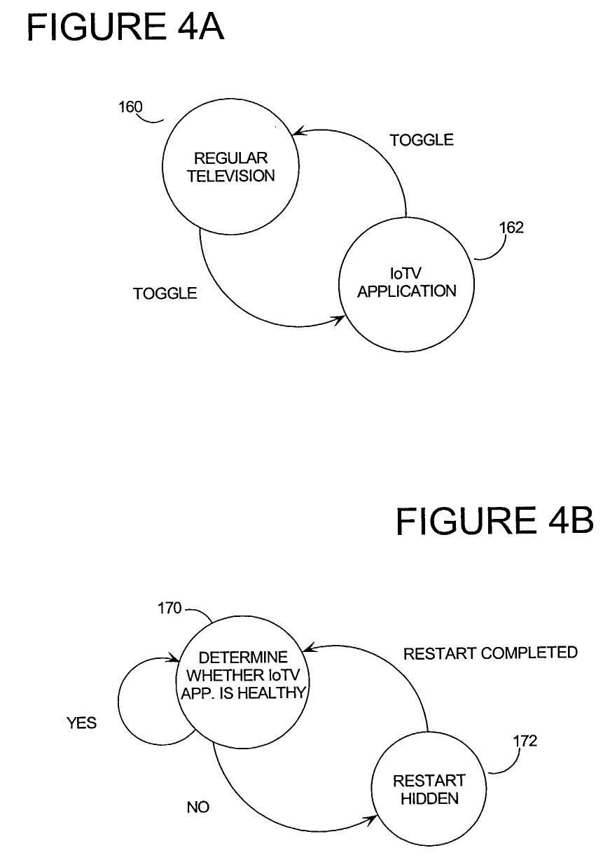

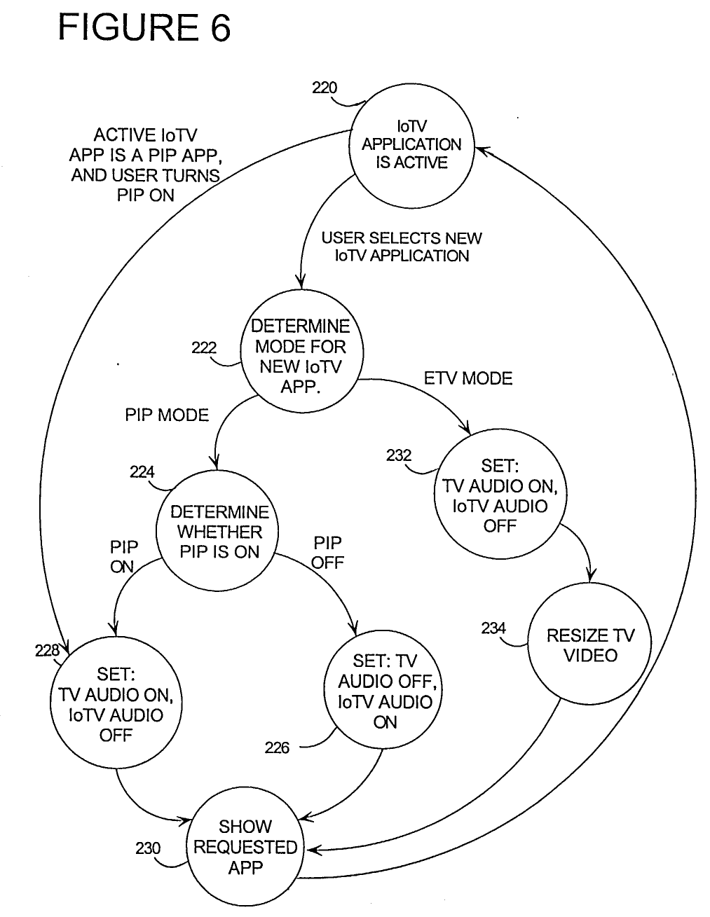

Operation of the set-top box 40 in the preferred embodiment of the invention includes the simultaneous execution of three different threads in a real-time, multi-tasking operating environment. These three software routines are presented in the state diagrams of FIGS. 4A and 4B, and in FIG. 6. This is done so that the state of more that one service can be maintained simultaneously. Multiple services could also be supported in a single-tasking environment using an integrated software program, however this is a far less flexible solution.

FIG. 4A presents a routine similar to that of FIG. 1A, where the end user is able to toggle between two services: television viewing mode 160, and IoTV application mode 162. These two services were selected because of user demand. In the preferred embodiment, the end user is able to switch back and forth between a television program and an IoTV application simply by striking a “toggle” key on his mobile or stationary interface device.

In the same way, FIG. 4B presents a routine similar to that of FIG. 1B. In this routine, the health of the active IoTV application is monitored at state 170 regardless of whether the television service is being viewed or the IoTV application itself. This is done by keeping the IoTV application current, rather than closing it when the transfer is made to the television service. This allows the IoTV application to maintain the state of the IoTV application, continuing to receive updates (such as newly received email messages) and responses to requests (such as new Web pages). As noted above, this is easily accommodated using a multi-tasking operating system. If the IoTV application is found to be unhealthy at some point in time, then control passes to state 172 where the IoTV application is restarted. Once the restart has been completed, control can return to state 204.

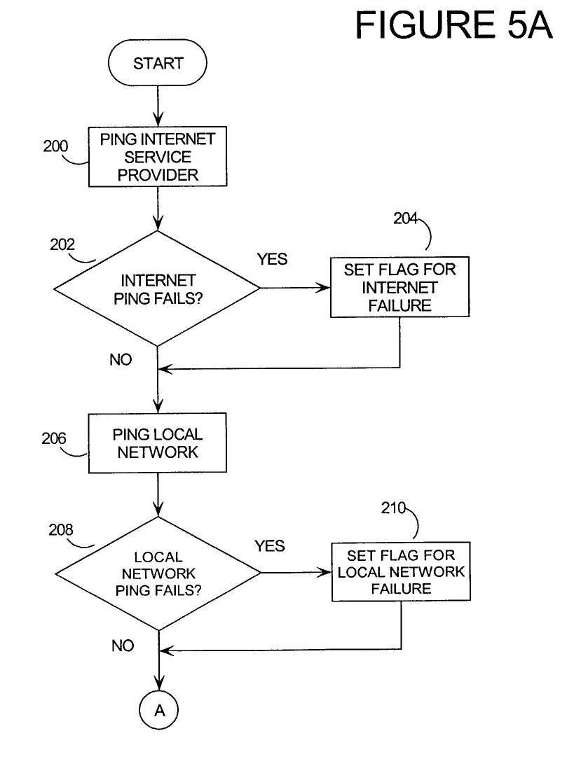

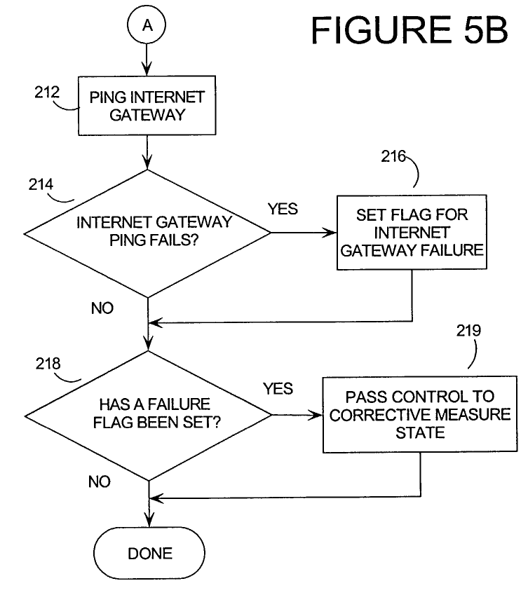

The step of determining whether the current IoTV application is healthy (state 170) will depend on the type of IoTV application that is current. An exemplary routine for analysing the health of an IoTV application is presented in the flow chart of FIGS. 5A and 5B. In short, this routine checks the connectivity and operability of the Internet connection at three levels: the Internet Service Provider, the Internet Gateway, and the home network connection. Clearly, the connectivity checks will depend on the architecture of the system, and even then, almost unlimited variations could be made.

The process typically begins at step 200 where the set-top box 40 “pings” the Internet Service Provider. A “ping” is a software utility used to determine whether a specific IP address is accessible. It works simply by sending a packet to the specified address and waiting for a reply. Alternatively, a “gethost” command could be executed, which causes a packet to be sent to the DNS (domain name server), asking it to resolve an IP address to a server. If the DNS responds, then obviously the Internet connection is operating.

It will be clear from the description which follows, that the purpose of issuing such “ping” and “gethost” commands is to obtain details regarding errors and failures. The more information that can be obtained in this respect, the more effective the corrective actions, such as the restart process 172 (and/or feedback to the end user) will be. Therefore, one could even issue “gethost” commands down to the application layer, where the Internet Service Provider uses different servers to support different applications (an email server, for example). Thus, the manner in which this step is effected will depend on the architecture of the system, and the level of detail that is desirable.

The routine then waits at step 202 for a certain period of time (300 milliseconds for example), and if no reply is received, the ping is considered to have failed. On failure, an “Internet failure” flag is set at step 204.

Control then passes to step 206 where a ping is issued to the home network. Again, a certain time period can be allowed for a response at step 208 and on failure, a “home network failure” flag is set at step 210.

Finally, the same process is repeated at steps 212-216 for checking the connectivity of the Internet Gateway 48. Note that the ping at step 212 will be different from that of step 200 above, as typically the Internet Gateway 48 will not be associated with an IP address.

Then, like the Internet and home network checks above, the routine sets an “Internet Gateway failure” flag at step 216, if this ping fails at step 214.

Having completed the set of connectivity checks, the system now checks to see whether any failure flags were set at step 218, and if so, passes control to the “corrective measure” state, at step 219 (see also state 172 of FIG. 4B). If no failure flags were set, the routine simply ends, though it will be repeated when state 170 is entered again.

While the routine of FIGS. 5A and 5B is shown to be executed in successive checks, the three tests that are performed could also be run as three separate software processes in a multi-threading operating system environment. See the co-pending patent application filed under U.S. application Ser. No. 10/202,908 filed on Jul. 25, 2002, under the title of “Method And System For Set-Top Box Service And Support”, for more details as to how this could be done.

Internet Service Providers typically have a number of access channels, for example, having different channels for email and Web Browsing. Thus, pings could be issued to each address. Similarly, a DNS ping could also be issued as part of the connectivity testing at step 200. A DNS (Domain Name System) server is a server that maintains a database of domain names (host names) and their corresponding IP addresses. The Internet uses IP addresses to identify locations, but these numeric addresses are not as easily remembered as alphanumeric domain names. Hence, a Web browser can be given a domain name such as www.mycompany.com, and it will be sent to a DNS server to be converted to the IP address 204.0.8.51.

Similar to the health checks, corrective measures in state 172 will also depend on the nature of the IoTV application and the environmental circumstances. In general, a hidden restart will be executed at state 172 (i.e. removing the IoTV application and re-launching it without putting it on the television 42 and disturbing the user), but other measures could also be taken:

1. advising the User of an error via a “connectivity failure”, “system error”, or “service not available” message;

2. referring the User to a section of an operating manual, or the telephone number for a telephone-based service and support person (the “help desk”); or

3. running other diagnostics, before advising the User of the problem.

The process presented in the state diagrams of FIGS. 4A and 4B, can be repeated periodically under the supervision of a hardware or software timer, or be hard coded into the operation of the STB 40. In the preferred embodiment of the invention, this testing is performed every 5 minutes, simply to keep the burden on the complete system under control. Technically, the system could perform these tests much more often, particularly the local tests (the local burden is insignificant compared to the burden that the real time content presents to the system). However, the remote burden is significant—if a typical community has 8,000 to 10,000 set-top boxes, it would not be practicable to perform the pinging more often than every five minutes or so.

Up until this point in the discussion, toggling between television and IoTV services has consisted of a complete switch of the audio and video from one service to the other. There may, however, be a need for more complex switches such as those presented by picture-in-picture (PIP) and enhanced television (ETV) modes. PIP allows the video signals of two (or more) services to be viewed simultaneously; one image filling a small box on the television screen and the other image filling the remainder of the screen. ETV allows the audio of the television broadcast to be heard while the television screen is filled with the video of the IoTV service. This might be desirable, for example, if the end user wishes to check his email during the commercials of a television program. By hearing the television audio he will know when his television program has returned, so he can toggle back from the email screen. A software process for managing these transitions is presented in the state diagram of FIG. 6.

Operation of the state-diagram of FIG. 6 could start at any point, but it is most logical to begin the description at state 220, where a selected (or default) IoTV application is active. An active IoTV application is one which will be available on the television 42 when the toggle is actuated to present the IoTV application. As will become clear, this means that the video content of the IoTV application will be presented on the television 42, and in some cases, so will the audio content of the IoTV application.

If the end user selects a new IoTV application while in state 220, the system must first determine whether the new IoTV application is a PIP (picture in picture) mode application, or a ETV (enhanced television) mode application at state 222. This determination could be made in a “hard coded” manner, for example, by having a cross table of IoTV applications and their modes, but this would limit the upgradability of the system. It is preferable for each IoTV application to have a mode parameter or flag associated with it, so that new IoTV applications can be supported without upgrading the client software.

ETV applications are applications which enhance the User's television experience, and may take a number of forms. A typical example is to allow the User to continue viewing and hearing their television program, but to pop up a new window which includes a printable coupon or a URL in a Web browser. The printable coupon may be communicated to the STB 40 over an Internet connection, or may simply be transmitted over a television cable by the television service provider. Many other ETV applications would be known to you skilled in the art, or would become clear from the teachings herein.

If the new IoTV application is found to be a PIP mode application, then the determination must be made at state 224, as to whether the STB 40 is currently in PIP mode. If the PIP mode is off, then control passes to state 226, where the television audio signal passing to the television 42 is disabled, and the audio from the IoTV application is allowed to pass to the television 42. In other words, with PIP off, it is desirable for the IoTV application to fill the television screen, and for the television 42 to play the audio signal from the IoTV application.

Conversely, if the PIP mode is found to be on at state 224, then control passes to state 228, where the audio signal passing from the IoTV application to the television 42 is disabled, and audio from the television is is allowed to pass to the television 42. Thus, the television service can be viewed in the PIP window and its audio signal heard, while the IoTV application is viewed in the background.

In either case, control then passes to state 230, where the video signal for the new IoTV application is passed to the video display of the television 42. Once this occurs, control passes back to step 220 where the IoTV application is active.

If the active IoTV application happens to be a PIP application, and the end user turns the PIP mode on while in state 220, then control passes directly to state 228. As noted above, the audio signal passing from the IoTV application to the television 42 will then be disabled, and the audio signal from the television service allowed to pass to the television 42. The video signal for the new IoTV application is then passed to the video display of the television 42 at state 230, before control returns back to step 220.

If it is determined at step 222 that the new IoTV application is an ETV application such as instant messaging, then control passes to state 232, where the audio signal passing from the IoTV application to the television 42 is disabled, and audio from the television service is allowed to pass to the television 42.

The dimensions of the ETV application are then sized to match the television display at state 234, before the show command is issued at state 230. Control then returns to state 220, where the selected IoTV application is now active.

The preferred embodiment of the invention presented in FIGS. 4-6 address many of the problems in the art.

While many set-top boxes only support one service at a time, the set-top box of the invention can support multiple services simultaneously. Therefore the end user does not have to close software applications and re-launch new applications each time a change is desired. In addition to the speed improvement of the invention, it also:

1. allows the state of hidden applications and services to be maintained;

2. automatically re-starts services which have failed while another service was being used;

3. allows switching between services to be done with a single key stroke, rather than wading through multiple layers of a menu system;

4. allows various combinations of audio and video signals from either a television or IoTV application to be presented simultaneously. For example, in ETV mode, the end user could be viewing his email application while listening to the television broadcast; and

5. allows this toggling to be performed in any one of three modes: TV, PIP or ETV.

Options and Alternatives

The invention is not limited by the nature of the content, software applications and physical components described herein. As well, it is clear that many alternative embodiments could also be employed. For example:

1. the connectivity tests can be made in response to certain requests. For example, when the User makes a request to toggle from one application to another, a ping could be made for the new service. This would test the new service before the User commits to a toggle that might cause his set-top box to lock up or crash;

2. complementary connectivity tests could be made along with other requests. For example, pings could be made to the various servers of an ISP when the User submits his login and password to access the ISPs system; or

3. diagnostic tests could also be run on a continuous basis for many other system services and physical components, such as for the High Bandwidth Service.

Many variations to the architecture are also possible. For example, the method and system of the invention could easily be applied to existing set-top boxes available from Scientific Atlanta, Echostar, Motorola, PACE, Microsoft, and the like.

### CONCLUSIONS

While particular embodiments of the present invention have been shown and described, it is clear that changes and modifications may be made to such embodiments without departing from the true scope and spirit of the invention.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, smart appliances, Bluetooth devices, personal digital assistants and Internet-ready telephones. Again, such implementations would be clear to one skilled in the art from the teachings herein, and do not take away from the invention.

What is claimed is:

1. A method of operation for a convergent multimedia device comprising the steps of:
responding to a toggle command being issued by an end user, by switching a display output between a first multimedia service and a second multimedia service; while
automatically checking the operability of said second multimedia service on an ongoing basis; and
responding to erroneous operation of said second multimedia service by taking corrective action as required.

2. The method of claim 1 further comprising the step of maintaining the state of said second multimedia service while it is hidden.

3. The method of claim 2 wherein said first multimedia service is a television broadcast service and said second multimedia service is an Internet over television (IoTV) service.

4. The method of claim 3 wherein said step of maintaining comprises the step of receiving new email messages as they arrive.

5. The method of claim 3 wherein said step of maintaining comprises the step of receiving new Web pages as they arrive.

6. The method of claim 3 wherein said step of taking corrective action comprises the step of re-booting a software application.

7. The method of claim 6 wherein said step of taking corrective action comprises the step of re-booting a Web browser software application.

8. The method of claim 6 wherein said step of taking corrective action comprises the step of reinitializing a connection to an Internet Service Provider (ISP).

9. The method of claim 3 wherein said step of automatically checking comprises the step of:
periodically issuing a “ping” to an Internet network, thereby checking connectivity between said convergent multimedia device and an address on said Internet.

10. The method of claim 3 wherein said step of automatically checking comprises the step of:
periodically issuing a “gethost” command to an Internet network, thereby checking connectivity between said convergent multimedia device and an address on said Internet network.

11. The method of claim 3 wherein said step of automatically checking comprises the step of:
periodically checking connectivity between said convergent multimedia device and a local network.

12. The method of claim 3 wherein said step of automatically checking comprises the step of:
periodically checking connectivity between said convergent multimedia device and a local gateway.

13. The method of claim 3, wherein said convergent multimedia device is a set-top box (STB), and said STB is connected to a computer with a display screen and an audio output device.

14. The method of claim 3, wherein said convergent multimedia device is a set-top box (STB), and said STB is connected to a television.

15. The method of claim 4 wherein said method steps are performed in a multi-tasking environment.

16. The method of claim 4 wherein said step of switching comprises the further step of determining whether said IoTV service is a picture in picture (PIP) or enhanced television (ETV) application.

17. A convergent multimedia system comprising:
an Internet Service Provider (ISP) connected to an Internet network;
a convergent multimedia device connected a display screen and an audio output;
a communication network connecting said convergent multimedia device to said ISP, allowing communication between said convergent multimedia device and said ISP; and
a television broadcast network connected to said convergent multimedia device;
said convergent multimedia device being operable to perform the steps of:
responding to a toggle command being issued by an end user, by switching between a first multimedia service received via said television broadcast network and a second multimedia service received via said communication network connecting said convergent multi-media device to said ISP;
while automatically checking the operability of said second multi-media service on an ongoing basis; and
responding to erroneous operation of said second multimedia service by taking corrective action as required.

18. The system of claim 17, wherein said communication network connecting said convergent multimedia device to said ISP comprises a digital subscriber line (DSL) communication network.

19. The system of claim 17, wherein said communication network connecting said convergent multimedia device to said ISP comprises cable modems and a television cable network.

20. The system of claim 17, wherein said convergent multimedia device is a set-top box (STB) and said display screen is incorporated in a computer.

21. The system of claim 17, wherein said convergent multimedia device is a television set-top box (STB) and said display screen is incorporated in a television.

22. The system of claim 17, wherein said convergent multimedia device includes a multitasking operating system.

23. The system of claim 22, wherein said multitasking operating system comprises a public-domain operating system and a windows manager.

24. The system of claim 22, wherein said multitasking operating system comprises a Linux operating system and a windows manager.

25. The system of claim 17, wherein said television broadcast network comprises a satellite transmission network.

26. A television set-top box comprising:
means for responding to a toggle command being issued by an end user, by switching a display output between a first multimedia service and a second multimedia service;
means for automatically checking the operability of said second multimedia service on an ongoing basis; and
means for responding to erroneous operation of said second multimedia service by taking corrective action as required.
